(19) United States
(12) Patent Application Publication
(10) Pub. No.: US 2014/0070724 A1
(43) Pub. Date: Mar. 13, 2014

(54) Recessed Luminaire

(71) Applicant: ABL IP Holding LLC, Conyers, GA (US)

(72) Inventors: Carl Gould, Golden, CO (US); Peter K. Nelson, Denver, CO (US); Chris Sorensen, Denver, CO (US); Chris Slaughter, Denver, CO (US); Kevin F. Leadford, Evergreen, CO (US)

(21) Appl. No.: 13/866,971

(22) Filed: Apr. 19, 2013

Related U.S. Application Data
(60) Provisional application No. 61/699,459, filed on Sep. 11, 2012.
(60) Provisional application No. 61/784,748, filed on Mar. 14, 2013.

(51) Int. Cl. F21V 13/02; H05B 37/02

(52) U.S. Cl. CPC F21V 13/02; H05B 37/02
USPC 315/291; 362/231; 362/235; 362/249.01

(57) ABSTRACT

Embodiments of the invention are directed to wall recessed two-component luminaires. The two components can include a primary optical subsystem and a secondary optical subsystem. The primary optical subsystem can provide indirect lighting, illuminate an architectural space upward toward a ceiling, and/or have greater luminous flux than the secondary optical subsystem. The secondary optical subsystem can provide direct lighting, illuminate an architectural space horizontally and/or downward, provide lit appearance, provide direct view color and/or color gradients, provide direct view luminance and/or luminous gradients, and/or provide lighting for ambience.

### CROSS REFERENCE TO RELATED APPLICATIONS

This application claims priority to U.S. Provisional Patent Application No. 61/699,459, filed Sep. 11, 2012, entitled “Wall-Recessed Two Component Luminaire,” and to U.S. Provisional Patent Application No. 61/784,748, filed Mar. 14, 2013, entitled “Wall-Recessed Two Component Luminaire.” Each of these references is hereby incorporated by reference in its entirety for all purposes.

### BACKGROUND

Rooms are often illuminated by either natural light or by artificial light. Natural light has many benefits over artificial light, but may not be available or be practical. An advantageous arrangement for some spaces may be a combination of artificial and natural light. Imitation windows exist, but they are typically mounted on the wall and only emit a single type of light. This tends to give the appearance of a television screen or backlit sign/poster on the wall and fails to provide either the type or amount of light necessary to light the room.

### BRIEF SUMMARY

The terms “invention,” “the invention,” “this invention,” and “the present invention” used in this patent are intended to refer broadly to all of the subject matter of this patent and the patent claims below. Statements containing these terms should not be understood to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to the entire specification of this patent, all drawings and each claim.

Embodiments of the invention are directed to wall recessed two-component luminaires. The two components can include a primary optical subsystem and a secondary optical subsystem. In some embodiments, the primary optical subsystem can provide indirect lighting, illuminate an architectural space indirectly by projecting light upward toward a ceiling, and/or provide light with more lumens than the secondary optical subsystem. In some embodiments, the secondary optical subsystem can provide direct lighting, illuminate an architectural space horizontally and/or downward, provide lit appearance, direct view color, direct view luminance, and/or lighting for ambience.

### BRIEF DESCRIPTION OF THE DRAWINGS

Illustrative embodiments of the present invention are described in detail below with reference to the following figures:

FIG. 1 shows the photometric distribution from a primary optical subsystem and a secondary optical subsystem of a wall recessed two-component luminaire according to some embodiments of the invention.

FIG. 2 shows a cross section of a backlit, wall recessed luminaire according to some embodiments of the invention.

FIG. 3 shows a cross section of a wall recessed luminaire according to some embodiments of the invention.

FIG. 4 shows a cross section of a wall recessed luminaire according to some embodiments of the invention.

FIG. 5 shows a cross section of a wall recessed luminaire according to some embodiments of the invention.

FIG. 6 shows a cross section of a backlit wall recessed luminaire according to some embodiments of the invention.

FIG. 7 shows a cross section of a wall recessed luminaire according to some embodiments of the invention.

FIG. 8 shows a cross section of a wall recessed luminaire according to some embodiments of the invention.

FIG. 9 shows a back view of a luminaire according to some embodiments of the invention.

FIG. 10 shows a back panel with a reflective insert according to some embodiments of the invention.

FIGS. 11A, 11B, 11C and 11D show examples of a wall recessed luminaire according to various embodiments of the invention from a wall facing perspective.

FIGS. 12A and 12B show front views of wall recessed housing according to some embodiments of the invention.

FIG. 13 shows a translucent optical element placed over aperture according to some embodiments of the invention.

FIG. 14 shows an inset that can be added to the room side of the wall and coupled with the functional components of the luminaire disposed within a luminaire.

FIG. 15A shows a side-view of an LED circuit board arranged with a lens according to some embodiments of the invention.

FIG. 15B shows a three dimensional view of a TIR lens according to some embodiments of the invention.

FIG. 16 shows a lens and a circuit board positioned within a heat sink according to some embodiments of the invention.

FIG. 17 shows an exploded view of portions of primary optical subsystem according to some embodiments of the invention.

FIG. 18 shows a block diagram of a controller coupled with a primary optical subsystem and a secondary optical subsystem.

FIG. 19 shows an illustrative computational system for performing functionality to facilitate implementation of embodiments described herein.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the invention are directed toward a two component, wall recessed (or surface mounted) luminaire that includes a primary optical subsystem and a secondary optical subsystem. In some embodiments, the primary optical subsystem can be configured to illuminate while the secondary optical subsystem can be configured to provide aesthetic lighting. Various different examples, embodiments and configurations of this general concept are described below.

In some embodiments, each subsystem may include one or more light sources, lenses, reflectors, collimators, diffusing optical elements, controllers, hardware, etc. Generally speaking, the primary optical subsystem can direct light upward relative to the luminaire to provide indirect lighting within an architectural space. The secondary optical subsystem can direct light horizontally and/or downwardly to directly illuminate the architectural space, provide lit appearance, provide direct view color, and/or provide direct view luminance. In some embodiments, both the primary optical subsystem and the secondary optical subsystem illuminate the architectural space from the same wall cavity or a cavity designed to be inserted into a wall. In some embodiments, this combination of primary and secondary optical subsystems can provide an illumination within the architectural space that shares qualities of or is suggestive of natural light from a window, portal, or translucent architectural element (e.g. glass block).

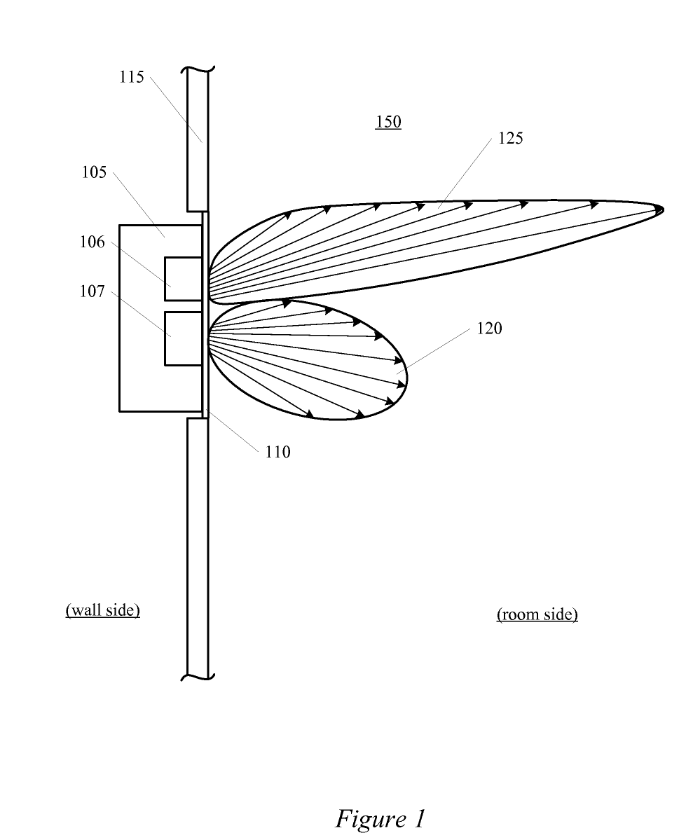

FIG. 1 shows a block diagram example of a photometric distribution from primary optical subsystem 106 and secondary optical subsystem 107 according to some embodiments of the invention. The blocks showing primary optical subsystem 106 and secondary optical subsystem 107 are functional block diagrams only. Luminaire 105 is shown recessed within wall 115 behind front optical element 110 fitting within an aperture. Luminaire 105 can include primary optical subsystem 106 and secondary optical subsystem 107. Each optical subsystem can include one or more discrete light sources such as light emitting diodes (LEDs), optical elements (e.g., lenses, diffusers, reflectors, etc.), control circuitry, power, etc. In some embodiments, light from both primary optical subsystem 106 and secondary optical subsystem 107 can be distributed into architectural space 150 from the same cavity within wall 115. Moreover, some overlap between the photometric distribution from primary optical subsystem 106 and secondary optical subsystem 107 can, but does not have to, occur.

Primary photometric distribution 125 is an example of the photometric distribution of light from primary optical subsystem 106 within luminaire 105. Primary photometric distribution 125 directs light substantially upwards relative to luminaire 105 in such a way that the light can be directed along a ceiling to indirectly illuminate the architectural space. For example, primary optical subsystem 106 can cast some of the light across the ceiling. As another example, the majority of the light can be directed above horizontal (e.g., above the luminaire when disposed within a wall); for example, more than 70%, 75%, 80%, 85%, 90%, 95%, or 100% of the light from primary optical subsystem 106 can be directed above horizontal. In some embodiments, the components that make up primary optical subsystem (e.g., LEDs, lenses, heat sinks, etc.) are generally not viewable by an occupant of the architectural space. In some configurations, the upward projection of the primary optical subsystem 106 can ensure that this is so, and in other configurations, the primary optical subsystem can be positioned within the luminaire body beneath the aperture to ensure that it is not seen by an occupant.

Secondary photometric distribution 120 is an example of the photometric distribution of light from secondary optical subsystem 107 within luminaire 105. Secondary photometric distribution 120 distributes light directly into the architectural space. In some embodiments, light from the secondary optical subsystem 107 can uniformly fill the architectural space.

In some embodiments, most of the light provided by the secondary optical subsystem is directed horizontally and/or downwardly. For example, in some embodiments, more than 50%, 55%, 60%, 65%, 70%, 75%, 80%, 85%, 90%, 95%, or 100% of the light can be directed at or below horizontal. In other embodiments, the secondary optical subsystem can direct light with a largely uniform distribution.

In some embodiments, some crossover between the two photometric distributions 125, 120 may occur. For example, in some embodiments, secondary optical subsystem 107 can emit a significant percentage of its light in an upward direction. In some embodiments, the combined photometric distribution can be primarily above horizontal. For example, more than 75%, 80%, 85%, 90%, 95%, or 100% of the combined photometric distributions can be directed above horizontal.

Primary optical subsystem 106 can provide light with a number of different characteristics in addition to the photometric distribution. In some embodiments, primary optical subsystem 106 can provide light with more luminous flux than the secondary optical subsystem. In other embodiments, primary optical subsystem 106 can provide mostly white light. For instance, primary optical subsystem 106 can provide light with various spectral characteristics similar to various white light sources that are commonly available. Primary optical subsystem 106 can provide light that varies in time according to, or suggestive of, various environmental conditions such as, for example, the time of day, the day of the year, etc. Primary optical subsystem 106 can include a plurality of LEDs of various colors and/or white LEDs of various color temperatures. Primary optical subsystem 106 can also include an optical element that distributes the light according to the photometric distribution shown in FIG. 1.

Secondary optical subsystem 107 can also provide light with a number of different characteristics in addition to the photometric distribution. In some embodiments, secondary optical subsystem 107 can provide light with less luminous flux than primary optical subsystem 106. In other embodiments, the secondary optical subsystem can provide light that is substantially distributed horizontally and/or downwardly from the cavity such that the light is occupant observed and/or side viewed. In other embodiments, the secondary optical subsystem can provide light of various colors, brightness gradients, and/or effects. In some embodiments, the secondary optical subsystem can provide light with a specific or potentially user specified ambiance; for example, with various mood or thematic colors, or to be suggestive of natural light or a view of the sky, etc.

In yet other embodiments, the primary and/or secondary optical subsystem can provide light that varies according to any number of conditions such as, for example, the time of day, the day of the year, the season, the geographic location, the local weather conditions, user input, presence detection, music being played in the architectural space, etc. In some embodiments, secondary optical subsystem can provide various luminance and/or chromatic gradients across the aperture of the wall recessed luminaire as viewed by a user. In some embodiments, both the primary optical subsystem and the secondary optical subsystem can provide various luminance and/or chromatic gradients in conjunction with one another. For example, to simulate the passage of a cloud across the aperture, the primary optical subsystem can provide less light and/or different colors while the secondary optical subsystem can provide a different color scheme.

As noted above, in various embodiments, primary optical subsystem 106 and secondary optical subsystem 107 can provide light with a number of different characteristics. In some embodiments, primary optical subsystem 106 can be tailored to illuminate architectural space 150 with light having characteristics that are different than the characteristics of light provided by secondary optical subsystem 107.

In some embodiments, primary optical subsystem 106 can direct light upwardly to indirectly illuminate architectural space 150 and secondary optical subsystem 107 can direct light horizontally and/or downwardly in a diffuse manner to directly illuminate architectural space 150. Moreover, primary optical subsystem 106 can illuminate architectural space 150 with more light (e.g., provide light with more lumens and/or energy). In some embodiments, primary optical subsystem 106 can contribute more than 50% of the total light output of luminaire 105. In some embodiments, the primary optical subsystem can provide over 70%, 75%, 80%, 85%, 90% or 95% of the total light output of luminaire 105. And, in some embodiments, primary optical subsystem 106 can illuminate architectural space 150 with primarily white light, while secondary optical subsystem 107 can illuminate architectural space 150 with light having more color than primary optical subsystem 106. In some embodiments, primary optical subsystem 106 may partially illuminate the architectural space downward or horizontal.

In some embodiments, secondary optical subsystem 107 can provide light with qualities that are suggestive of natural light or a view of the sky through a window, portal, or translucent architectural element (e.g. glass block). In still further embodiments, the secondary optical subsystem may produce an illusion of depth or a perception of ambiguous depth within the aperture when viewed by an occupant of the architectural space. Moreover, secondary optical subsystem 107 can provide a lit appearance, direct view color and/or color gradients, direct view luminance and/or luminous gradients, and/or lighting for ambience.

In some embodiments, the color, brightness and/or distribution provided by secondary optical subsystem 107 and/or primary optical subsystem 106 can change over time. These changes can occur based on a program executed by a controller coupled with the light sources that modifies the lighting parameters over time.

In some embodiments, a program can operate to control the lighting parameters of a number of luminaires in use together. Moreover, any number of programs can be used. For example, a program can operate the lights to simulate daylight. Moreover, the program can change the light parameters throughout the day to simulate the sun passing through the sky. Such a program, for example, can vary based on the geographic location of the luminaire in use. As another example, a program can operate the lights to simulate a cloud passing overhead. Any number of sky patterns can be used. In some embodiments, the program can include sunset and sunrise simulations.

In some embodiments, a program can operate a luminaire to change its color presentation over time. This can include, for example, changing various color patterns within the full spectrum of color or changing the saturation of a given color or the brightness. In some embodiments, a program can operate to change colors across an array of luminaires. In this way, different luminaires can provide different color at different times. Moreover, the saturation of a color can change over time within one luminaire or across multiple luminaires. The brightness can also change across multiple luminaires.

In some embodiments, a program can change dynamically over time or in response to certain inputs. These inputs can include time of day, flipping of a switch, proximity detection, temperature, humidity, cloud conditions, time of year, etc.

In some embodiments, the vertical and/or horizontal luminous presentation (or light gradient) of the luminaire can change over time. This can include changing any number of characteristics of the light, such as the brightness, color, hue, saturation, etc. across the luminaire. This can also include changing a color profile vertically and/or horizontally across the luminaire. This can be accomplished, for example, by varying the characteristics of the top and bottom LEDs differently over time and/or varying the characteristics of left and right LEDs differently over time.

In some embodiments, front optical element 110 includes one or more panes of glass or other transmissive, translucent, or transparent material (e.g., plastic, Plexiglas, etc.). In some embodiments, front optical element 110 can include multiple layers, materials or elements, and/or may have properties related to the reflection, refraction, scattering, or diffusion of light. In some embodiments, front optical element 110 can cover the entire front of the luminaire 105. In other embodiments, front optical element 110 can include multiple panes that cover portions of the aperture within wall 115. In some embodiments, front optical element 110 can be translucent or hazy; can include glazing that provides the look of a transom window, clearstory and/or glass block; and/or can include an optical filter that allows light to pass with wavelengths that simulate the spectral profile (color) or brightness of daylight. And in yet other embodiments of the invention, front optical element 110 may be omitted.

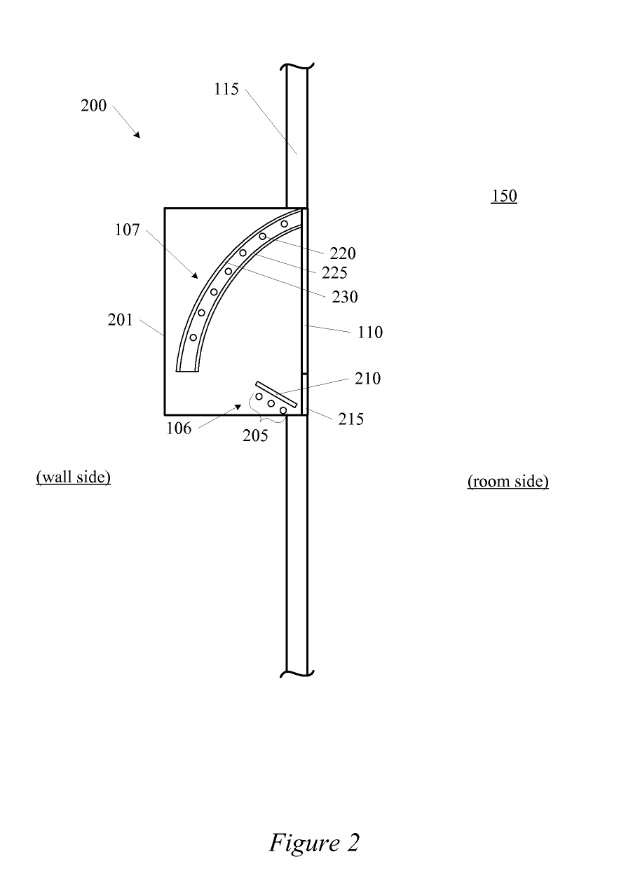

FIG. 2 shows a cross section of a backlit luminaire 200 according to some embodiments of the invention. In this embodiment, primary optical subsystem 106 is shown to include a plurality of LEDs 205 and optical element 210 disposed within luminaire housing 201. Optical element 210 can focus, direct, and/or control the dispersion, direction and/or angle of the light from the LEDs. For example, optical element 210 can direct light emitted from LEDs 205 upwardly (e.g., toward the ceiling) within architectural space 150.

In this embodiment, secondary optical subsystem 107 is a backlit arrangement that includes a plurality of LEDs 220, reflective back surface 230, and translucent optical element 225 disposed within luminaire housing 201. A translucent optical element 225 may or may not be curved along either or both a vertical or horizontal profile. LEDs 220 can illuminate the architectural space through translucent optical element 225. Translucent optical element 225 can include a diffuser; one or more layers, materials or elements; and/or have properties related to the reflection, refraction, scattering, or diffusion of light. In some embodiments, translucent optical element 225 is a translucent film. Some light emitted from LEDs 220 can be directed toward translucent optical element 225. The light is diffusely scattered, and/or directed horizontally and/or downwardly into architectural space 150 by translucent optical element 225. Other light emitted from LEDs 220 can be reflected from reflective back surface 230 and diffusely scattered, and/or directed horizontally and/or downwardly into architectural space 150 by translucent optical element 225. LEDs 205 and/or LEDs 220 can include a plurality of LEDs (or other light sources, such as an OLED panel or sheet in place of LEDs 220 and either with or without the inclusion of reflective back surface 230 or translucent optical element 225) disposed horizontally along the length of the luminaire wall (into the page).

In some embodiments, light from both primary optical subsystem 106 and secondary optical subsystem 107 can illuminate the architectural space from the same cavity within wall 115 and/or through front optical element 110. In other embodiments, the luminaire may not include a front optical element 110. In some embodiments, shade 215 can be positioned to block the view of the interior of the luminaire, including the primary and/or secondary optical subsystems. Shade 215 can be positioned near the bottom of the aperture within which the luminaire is placed to shield the view of the interior of the luminaire from below or from the horizontal and/or can comprise non-translucent or non-transparent material. Shade 215 can have a finish similar to the rest of the wall, and/or be finished with the wall to have a seamless appearance.

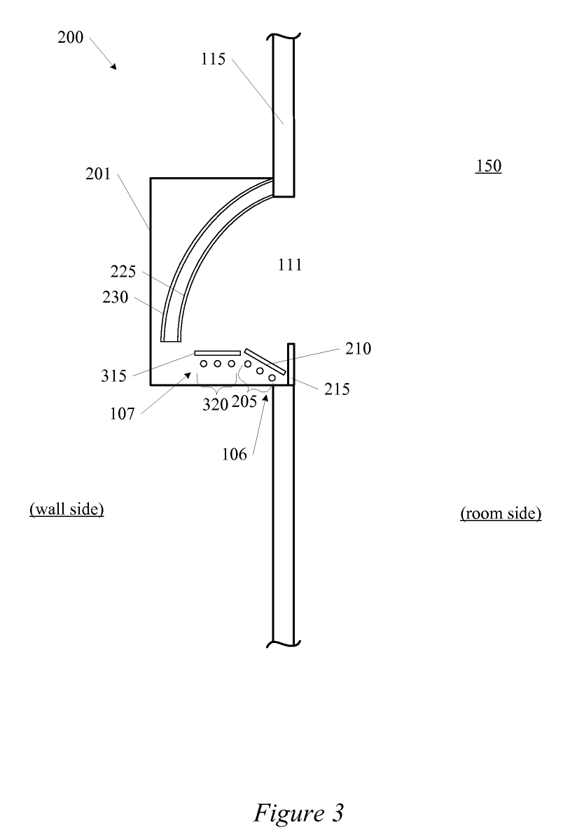

FIG. 3 shows a cross section of luminaire 200 according to some embodiments of the invention. This luminaire 200 can fit within a single cavity in wall 115. In some embodiments, primary optical subsystem 106 can include a plurality of LEDs 205 and optical element 210 arranged to illuminate the ceiling of the architectural space. For example, optical element 210 can direct light emitted from LEDs 205 upwardly (e.g., toward the ceiling) within architectural space 150. In this embodiment, there is no front optical element. In this embodiment, aperture 111 provides an opening within wall 115. Light from the primary and secondary light sources exits the luminaire through aperture 111. Aperture 111 can include any number of configurations that allows the light from primary optical subsystem 106 and secondary optical subsystem 107 to exit the housing and pass through wall 115. Aperture can include any opening within the luminaire housing and the wall.

Secondary optical subsystem 107 can include a front-lit arrangement that includes a plurality of LEDs 320, reflective back surface 230, and/or translucent optical element 225. In some embodiments, only reflective back surface 230 is used. Moreover, various other reflective, translucent, or other surfaces and/or materials can be used. Furthermore, in some embodiments, reflective back surface 230 can be specular and/or diffusing. Most of the light emitted from LEDs 320 is directed toward translucent optical element 225 and/or reflective back surface 230 by optical element 315. Some of the light can then be reflected into architectural space 150 from translucent optical element 225, while other light can pass through translucent optical element 225 and be reflected off reflective back surface 230, and directed into architectural space 150 through translucent optical element 225. Either or both reflective back surface 230 and translucent optical element 225 can be shaped to direct light downwardly and/or horizontally into architectural space 150. For example, reflective back surface 230 and/or translucent optical element 225 can be shaped and/or angled in various ways to control the direction of the light, have particular color or luminance gradients, and/or have optical properties that achieve this directionality. Optical element 315 can focus, control, diffuse, and/or direct light toward reflective back surface 230 and translucent optical element 225.

LEDs 205 and/or LEDs 220 can include a plurality of LEDs (or other light sources) disposed horizontally along the length of the luminaire wall (into the page).

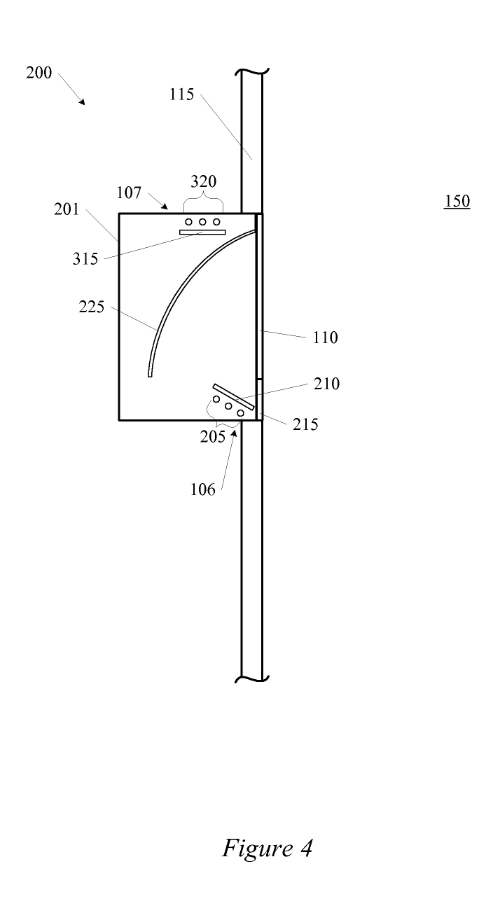

FIG. 4 shows a cross section of luminaire 200 according to some embodiments of the invention. Luminaire components are disposed within luminaire housing 201. In this embodiment, secondary optical subsystem 107 is moved behind translucent optical element 225. In some embodiments, a reflective back surface (like 230) can be included elsewhere within luminaire 200. In other embodiments, reflective back surface 230 is not used in luminaire 200.

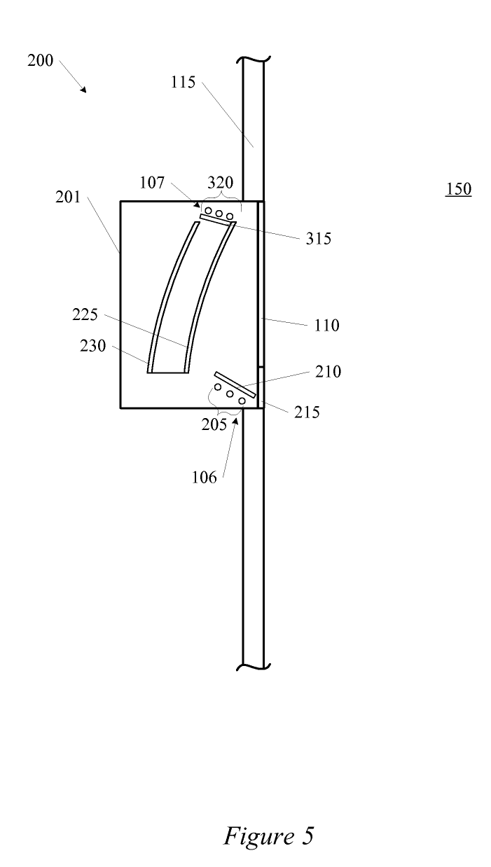

FIG. 5 shows a cross section of luminaire 200 according to some embodiments of the invention. Luminaire components are disposed within luminaire housing 201. In this embodiment, secondary optical subsystem 107 is moved to provide light between translucent optical element 225 and reflective back surface 230.

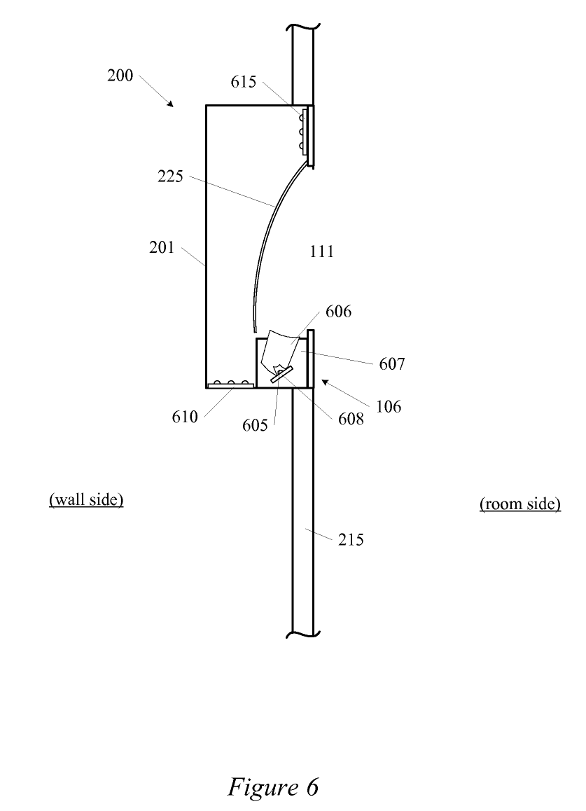

FIG. 6 shows a cross section of luminaire 200 according to some embodiments of the invention. Luminaire components are disposed within luminaire housing 201. Primary optical subsystem 106 is disposed position located inwardly within the housing relative the bottom peripheral edge of aperture 111 and proximate the inwardly facing surface of housing. In some embodiments, primary optical subsystem 106 can include a plurality of white or substantially white LEDs 605, circuit board 608, lens 606, and/or heat sink 607.

Secondary optical subsystem 107 can include a number of secondary light sources. For instance, secondary optical subsystem 107 can include LEDs 610 disposed above and/or below aperture 111. LEDs 610 may also be positioned to direct light upwards behind translucent optical element 225.

Secondary optical subsystem 107 can also include LEDs 615 positioned within the housing at a level above the top portion of aperture 111 near a peripheral edge of aperture 111 and can direct light inwardly toward the back surface of housing 201. The light from LEDs 610 and 615 can mix within housing 201 prior to passing through translucent optical element 225 and exiting through aperture 111. LEDs 615 and 610 can include a plurality of LEDs, for example, of one or more colors depending on the application.

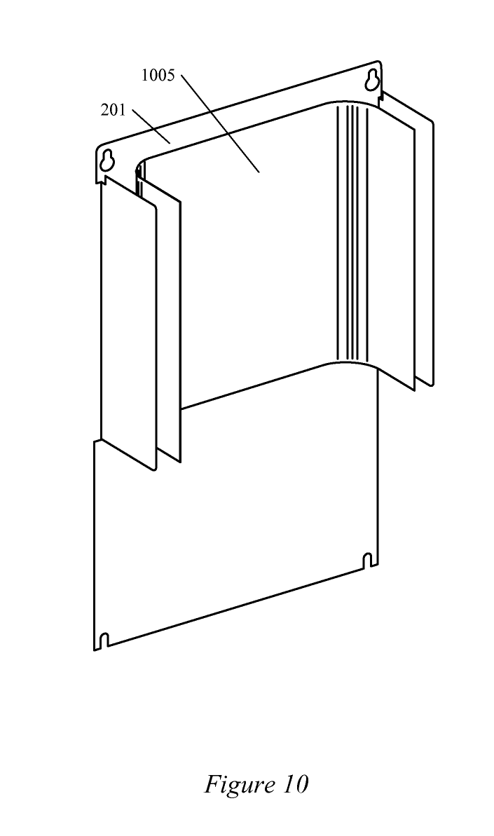

Luminaire 200 can also include a reflective back surface or reflective insert 1005 of housing 201 as shown in more detail in FIG. 10. This reflective back surface of housing 201 can be part of the luminaire body or an insert within the luminaire body. A reflective surface on the back of housing 201 can reflect light from LEDs 610 and LEDs 615 toward translucent optical element 225. LEDs may also be positioned on the side of translucent optical element 225. In some embodiments, housing 201 can be coated or made from any type of reflective material that allows the light from various secondary light source LEDs to mix within the body of luminaire 200 prior to passing through translucent optical element 225 and then exiting luminaire 200.

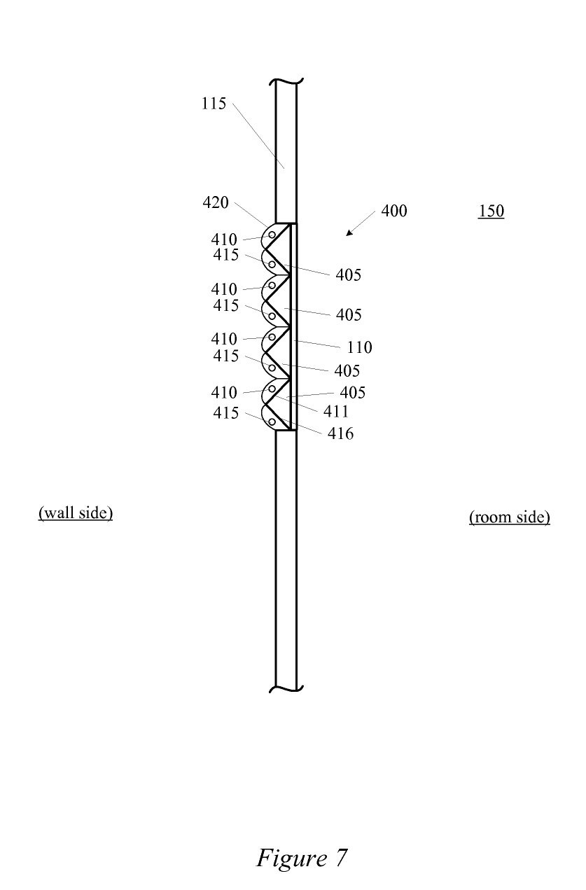

FIG. 7 shows a cross section of recessed luminaire 400 according to some embodiments of the invention. Recessed luminaire 400 can fit within a cavity located within wall 115. Recessed luminaire 400 can include a plurality of elongated prisms 405 that extend horizontally (into the page) and are disposed one on top of another vertically. Each prism 405 has a triangular cross section that can be equilateral, isosceles, and/or scalene. The prisms can vary in size, shape, dimension, angle and/or curvature. In some embodiments, each prism 405 can be arranged relative to one another such that one of the surfaces of each prism 405 forms a plane with one of the surfaces of other prisms 405.

Primary optical subsystem LEDs 415 can be positioned behind each prism (opposite the architectural space 150) below the apex of prism 405. In this configuration, light from primary optical subsystem LEDs 415 will pass through prism 405 toward the ceiling as shown by primary photometric distribution 125 in FIG. 1. The direction, size, and/or shape of the photometric distribution from primary optical subsystem LEDs 415 through prism 405 can vary depending on the shape of prisms 405.

Secondary optical subsystem LEDs 410 can be positioned behind each prism (opposite the architectural space 150) above the apex of prism 405. In this configuration, light from secondary optical subsystem LEDs 410 will pass through prism 405 downwardly and/or horizontally into the architectural space as shown by secondary photometric distribution 120 in FIG. 1. The direction, size, and/or shape of the photometric distribution from secondary optical subsystem LEDs 410 through prism 405 can vary depending on the shape of prisms 405.

In some embodiments, prisms 405 can be shaped to change the photometric distribution of light. For example, surface 416 of the prisms 405 nearest LEDs 415 can be shorter than surface 411 nearest LEDs 410. In this configuration, light from LEDs 415 can be directed upwardly at a steeper angle and light from LEDs 410 can be directed more horizontally. In some embodiments, the curvature of the prism faces can be changed to change the direction of the light. Various other sizes, dimensions, and/or angles can be used to change the direction, and/or angle of the light from LEDs 410 and 415. In some embodiments, the various prisms can have different shapes in order to provide a varied photometric distribution.

In some embodiments, front optical element 110 may not be used or it may be part of prisms 405. While four elongated prisms are shown, any number of prisms may be used. In some embodiments, reflective cover 420 can surround secondary optical subsystem LEDs 410 and/or primary optical subsystem LEDs 415 and reflect light into prisms 405.

Moreover, while each prism is shown associated with a single primary optical subsystem LED 415 and a single secondary optical subsystem LED 410, in some embodiments, multiple prisms can be associated with a primary optical subsystem and/or a secondary optical subsystem. In other embodiments, a single prism can be associated with a plurality of light sources. And, in some embodiments, secondary optical subsystem LEDs 410 and/or primary optical subsystem LEDs 415 can represent a plurality of light sources arranged horizontally along the elongated prism. In some embodiments, a diffuser (not shown) may be placed between secondary optical subsystem LEDs 410 and prisms 405 as well as between primary optical subsystem LEDs 415 and prisms 405. Such diffusers can spread the light across the prism to provide a horizontally uniform light presentation and/or mix colors from various light sources. In some embodiments, a diffuser can be placed between the prisms 405 and front optical element 110.

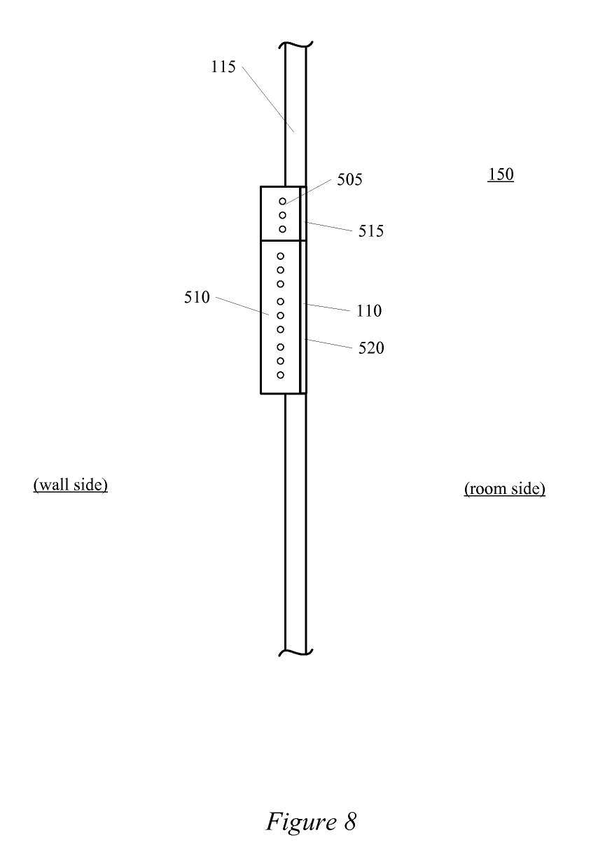

FIG. 8 shows another embodiment of a wall recessed luminaire. In this embodiment, primary optical subsystem 505 can be located within wall 115 above secondary optical subsystem 510. Primary optical subsystem 505 can include a plurality of LEDs or other light sources. Primary optical subsystem 505 in conjunction with primary optical element 515 (e.g., lens, diffuser, etc.) can direct light toward the ceiling, for example, according to primary photometric distribution 125 of FIG. 1. Secondary optical subsystem 510 in conjunction with secondary optical element 520 (e.g., lens, diffuser, etc.) can direct light horizontally and/or downwardly, for example, according to secondary photometric distribution 120 of FIG. 1. Secondary optical subsystem 510 can include, for example, any type of display panel(s) such as an LCD, OLED, LED matrix, or plasma display. In some embodiments, this wall recessed luminaire can include a plurality of LEDs. Various other geometric arrangements are possible. For example, the primary and/or secondary subsystems can be disposed in different locations in, on, and/or around aperture 111.

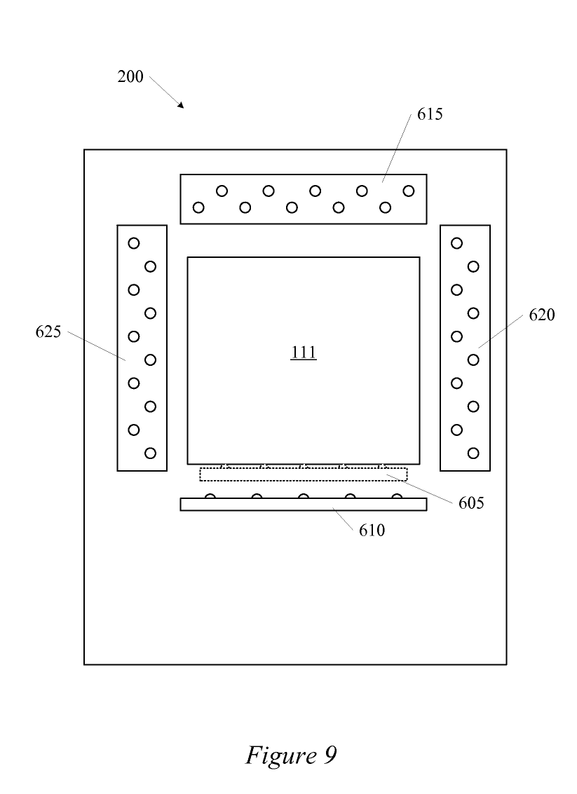

A back view of luminaire 200 similar to that shown in FIG. 6, is shown in FIG. 9. This view shows luminaire 200 covering aperture 111. Translucent optical element 225, while not shown, can be positioned such that light from the various light sources can pass through translucent optical element 225 prior to exiting the luminaire through aperture 111. Primary optical subsystem LEDs 605 can be positioned in front of translucent optical element 225. In this embodiment, the secondary light source includes four LED sources. These include LEDs 615 and LEDs 610 positioned as shown in FIG. 6. Secondary light source also includes LEDs 620 and 625 positioned on the sides of translucent optical element 225. Any of the LEDs 610, 615, 620, and 625 can be independently controlled.

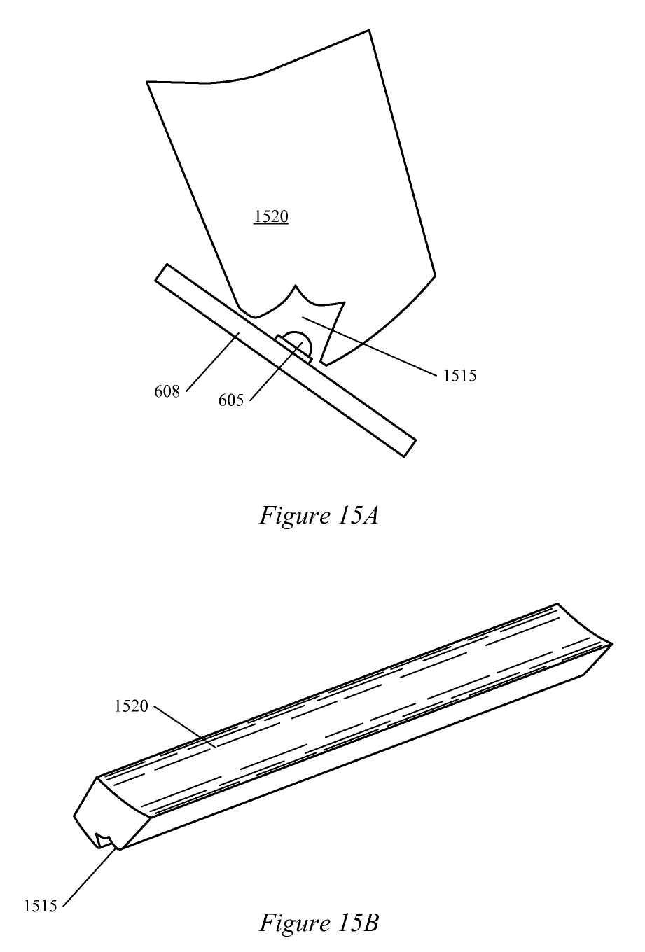

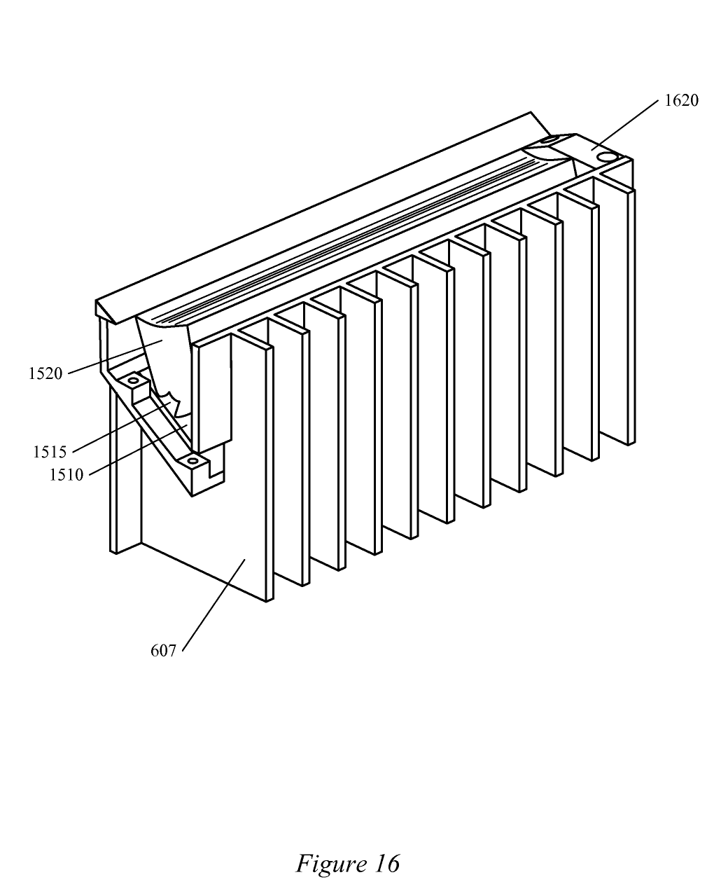

The LEDs that make up either or both primary or secondary optical subsystems can include any type, color, size, etc. of LED known in the art. Any configuration or arrangement of LEDs can be used as shown in the various embodiments of the invention. The LEDs can be disposed on a circuit board and may include optical elements such as lens placed on or near the LEDs on the circuit board as shown, for example, in FIGS. 15 and 16. Each of the secondary light source LEDs can be independently controlled and/or operated to produce various effects.

In some embodiments, LEDs 620 or 625 can be controlled to create light gradient across translucent optical element 225 when viewed from the outside. For instance, LEDs on one side can provide light having one color and LEDs on the other side may provide light of another color. In this way, the presented illumination can vary horizontally across the luminaire. Similarly, LEDs 615 and LEDs 610 can provide a similar effect in the vertical direction. Moreover, a combination of vertical and horizontal gradients can be provided.

LEDs 610, 615, 620, and 625 may produce light that is reflected off of the back panel of housing 201 or reflective insert 1005 shown in FIG. 10. Reflective insert 1005 can be made from any highly reflective material (e.g., White Optics™ 97). Reflective insert 1005 can also be made from a material that is diffusely reflective. The corners of reflective insert 1005 can have radii large enough to eliminate corner shadow.

In some embodiments, the back surface and/or side surfaces of housing 201 may be reflective and in such embodiments, reflective insert 1005 may or may not be used. The reflective back surface and/or reflective side surfaces of housing 201 and/or reflective insert 1005 can produce a light mixing chamber within the body of the luminaire. Some light from secondary light sources can be mixed within the body of the chamber after being reflected off the back or side surfaces of housing 201 and/or reflective insert 1005 prior to exiting through translucent optical element 225 (such as described in conjunction with the embodiment shown in FIG. 6). Some light can also exit the translucent optical element 225 without interaction with reflective back surface of housing 201 and/or reflective insert 1005.

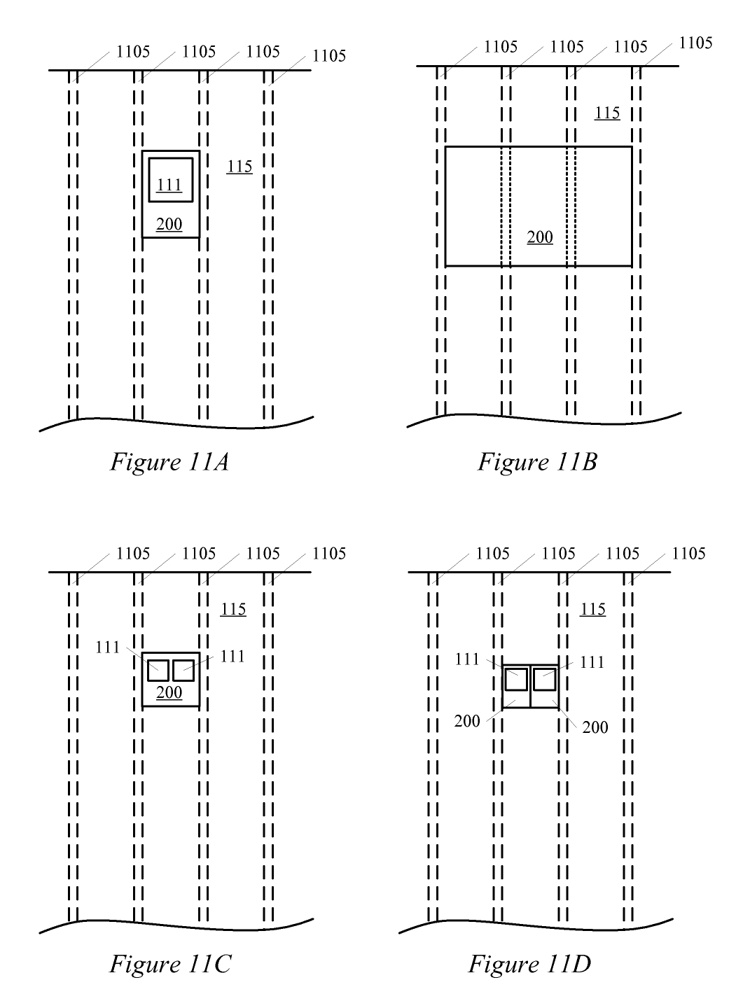

FIG. 11A shows luminaire 200 according to various embodiments of the invention from a wall facing perspective. As shown, luminaire 200 can fit in between two studs 1105 (e.g., 2×4 s or steel studs) within wall 115. Luminaire 200 can be recessed within the cavity in the wall between the two studs 1105. Aperture 111 is where light exits the luminaire into the architectural space. Aperture 111 can be any size. In some embodiments, aperture 111 can be 6 inches by 6 inches. The only that can be viewed by an individual.

FIG. 11B shows luminaire 200 spanning multiple studs 1105. In some configurations, light sources, controllers, optics, power, etc. shown in any of the embodiments may be separated into subsystems that are recessed within the wall between studs 1105. A common front optical element or aperture can span the various subsystems providing a look and feel to the occupant of a single visual element.

FIG. 11C shows a single luminaire 200 with two apertures 111 according to some embodiments of the invention. Separate or the same primary and secondary optical subsystems can illuminate the architectural space through both apertures. Luminaire 200 can fit between two studs 1105 within wall 115. Luminaire 200 can be recessed within the cavity in the wall between the two studs 1105. Apertures 111 can include optical systems that provide separate illumination profiles yet both fit within studs 1105. Apertures 111 can have any size that fits between studs 1105. In some embodiments, aperture 111 can be 12 inches by 12 inches or 6 inches by 6 inches.

FIG. 11D shows two recessed luminaires 200 that each illuminate via one aperture are fit together between two studs according to some embodiments of the invention. Each luminaire 200 can include separate aperture 111. In some embodiments, aperture 111 can be 6 inches by 6 inches.

In some embodiments, custom wall framing may be used to impart a polished appearance to the installation. Custom wall framing members can extend horizontally above and below the housing(s) and spanning multiple cut vertical studs.

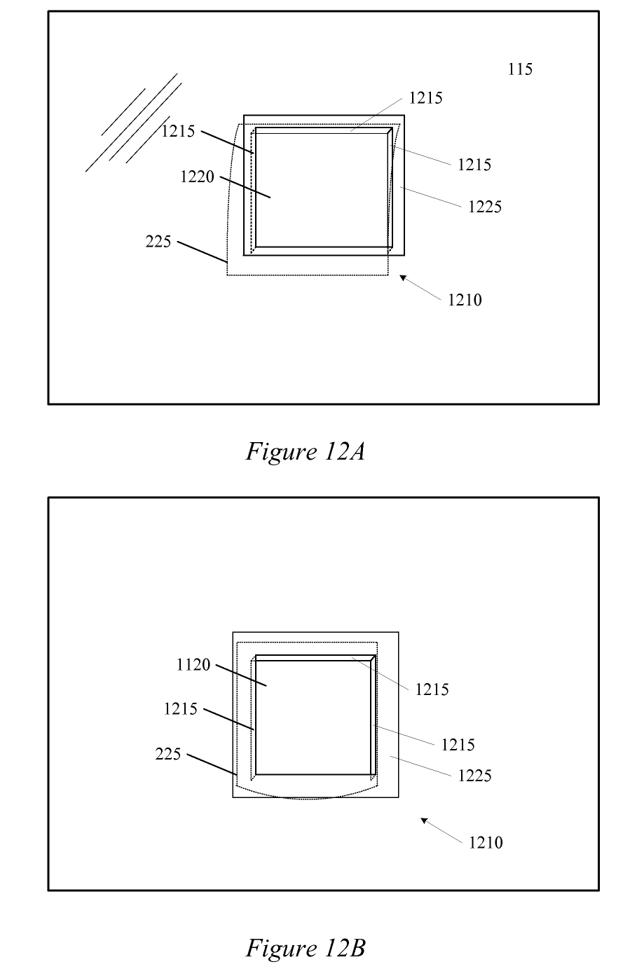

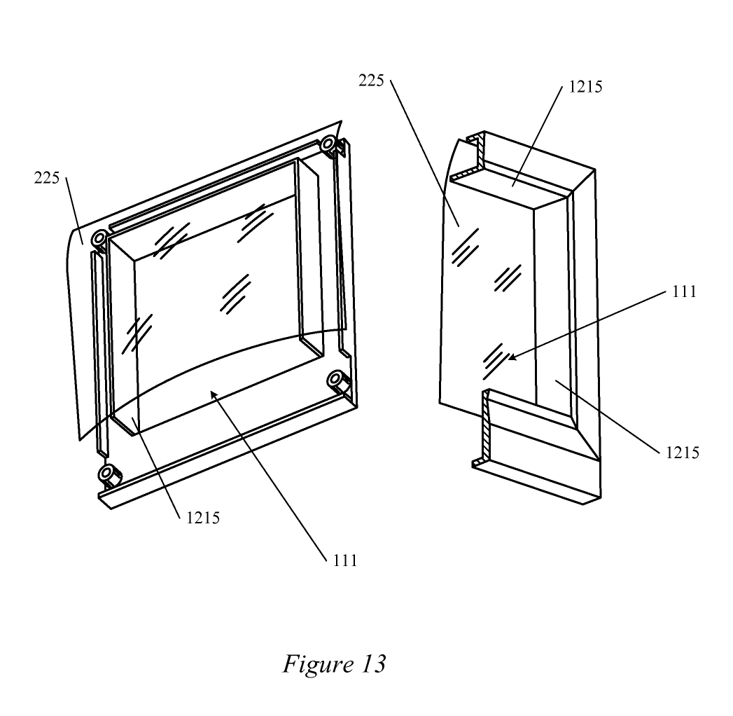

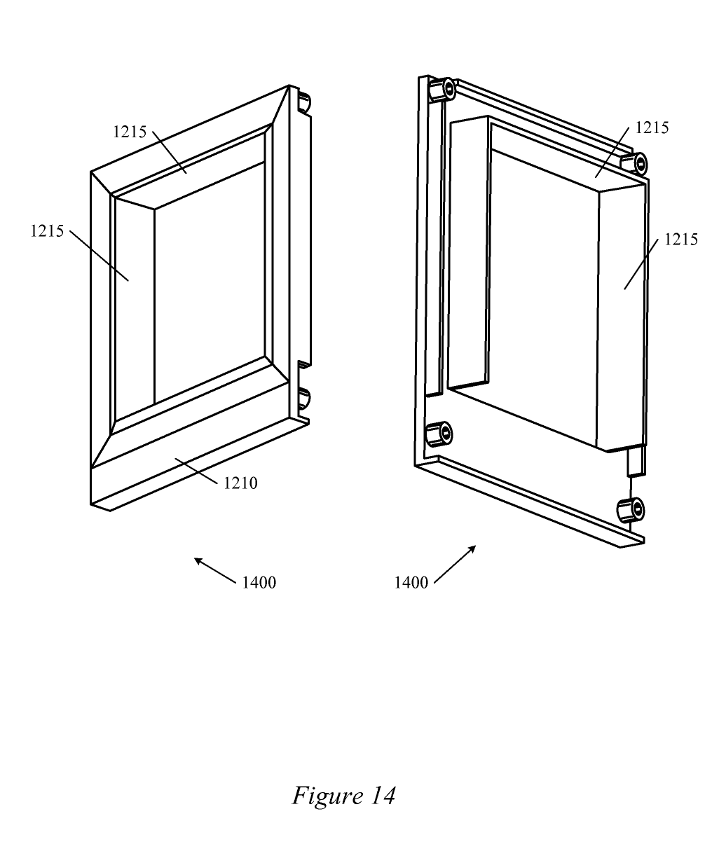

In some embodiments, the installation may include a trim piece, such as a frame 1210 that defines a frame opening 1220. The frame can be of any shape or design, for example, including, but not limited to, shapes or designs that are standard for window trim or picture frames. The frame may be integrally-formed with the luminaire housing or, alternatively, may be a separate trim piece (see FIGS. 13 and 14) that couples to the luminaire housing (or other structure) to ensure that the frame opening 1220 aligns with the wall aperture 111 so that light generated by the luminaire can exit through, or be visible within, the wall aperture 111. The thickness of the frame 1210 and the size of the frame opening 1220 can vary depending on the appearance desired for the installation. The frame 1210 may be positioned relative to the wall aperture 111 so that the front face 1225 of the frame is flush with the wall, inset back from the wall or extends over the wall beyond a wall aperture. For example, in some embodiments, the entirety of the frame 1210 is positioned within the wall aperture so that the front face 1225 of the frame 1210 is flush with the wall. The frame 1210 may have a contrasting appearance with the wall or may be finished to appear seamless with the wall. Alternatively, frame 1210 may have a thickness such that it extends along the wall beyond the wall aperture (thus giving the appearance of a picture frame or window). FIGS. 12A and 12B show front views of a luminaire housing according to some embodiments of the invention. In some embodiments, a luminaire can include frame 1210 that is flush with the wall and covers the perimeter of the wall-cavity that extends beyond the aperture. In other embodiments, frame 1210 extends over the wall and beyond the wall-cavity. Frame 1210, for example, can have thickness small enough and/or be made from a material that allows the wall and frame to have a finish or can be finished to appear seamless. A recessed luminaire can also include trim or a frame that is flush to the wall, inset from the wall or extends over the wall beyond the wall-cavity. The trim or frame can have any thickness and/or style. In some embodiments, the housing can include driver, power, and/or control logic.

In some embodiments, side surfaces 1215 (or insets) can extend backwardly from the frame 1210 into the wall cavity and/or into housing aperture 111. These side surfaces 1215 can frame portions of the wall aperture and/or luminaire aperture 111. In some embodiments, side surfaces 1215 can have a depth of 2.0, 1.75, 1.5, 1.25, 1.0, 0.75, 0.5, 0.25, etc. inches. The side surfaces 1215 can, but do not have to be, integrally formed with the frame 1210. These side surfaces 1215 can be finished to match the wall surface or have a clean architectural finish of their own. In some embodiments, depending on the location of various optical components, a wall recessed luminaire can include one, two, three, or four side surfaces 1215.

In one specific embodiment, three side surfaces 1215 can are provided on the frame 1210 within the aperture on the opposing sides and on the top of the frame. In some embodiments side surfaces 1215 provide depth to the installation (such as a window sill) and/or are used to shield from the view the internal components of the luminaire 200. In some embodiments, frame 1210 can be integral with side surfaces 1215. In some embodiments, LEDs or other optical components can be integrated within frame 1210 and/or side surfaces 1215.

FIG. 12A shows translucent optical element 225 having a vertical curve. FIG. 12B shows translucent optical element 225 having a horizontal curve. In yet other embodiments, translucent optical element 225 can have a curvature in both the vertical and horizontal directions. In some embodiments, translucent optical element 225 can also have a vertical and/or horizontal tilt relative to some axis. As shown in the figures, translucent optical element 225 can extend internally within the housing beyond the edges of the sides surfaces 1215 that extend inwardly into a wall aperture and luminaire housing aperture 111. In this way, the side surfaces 1215 can shield from view the edges of the translucent optical element 225 and the various components of both the first optical subsystem and the second optical subsystem.

In some embodiments, frame 1210 and/or side surfaces 1215 can be integral with the housing that is disposed within the wall. In other embodiments, frame 1210 and/or side surfaces 1215 can be part of separate outer inset that couples with the housing portion disposed within the wall. Such an inset is shown in FIG. 13.

In some embodiments, translucent optical element 225 can be collapsible, rollable, and/or flexible in order to be installed, replaced or removed through the aperture. In some embodiments, translucent optical element 225 may have slits, cuts, rivets, pegs, folds, flanges, wings, seams or gathers in order to provide the curvature and/or to fit within the housing. In some embodiments, translucent optical element 225 can be positioned within the housing without being coupled directly with the housing. In other embodiments, translucent optical element 225 can be coupled within the interior of the housing. In some embodiments, translucent optical element 225 can extend past the internal edges of side surfaces 1215 and/or can terminate near internal edges of the housing.

FIG. 13 shows translucent optical element 225 placed over aperture 111 when viewed from within the housing or behind aperture 111, when viewed from the front of the housing. In some embodiments, translucent optical element 225 can be positioned within the body of the luminaire and may be positioned from the top of aperture 111 toward the bottom of aperture as shown in FIG. 6. Translucent optical element 225 may be positioned away from the bottom peripheral edge of aperture 111 (or the interior facing housing surface) in order to provide space for primary optical subsystem to illuminate the architecture space without exiting through translucent optical element 225. This arrangement can result in translucent optical element 225 having a concave shape and/or tilt along a horizontal axis.

In some embodiments, translucent optical element 225, for example, can be a translucent film. In some embodiments, a clear or diffuse covering (e.g. front optical element 110 shown in FIG. 1) can be used to cover aperture 111.

FIG. 14 shows inset 1400 (or aperture trim piece) that can be added to the room side of the wall and coupled with the functional components of the luminaire disposed within a luminaire. Inset 1400 can be positioned on the wall (or any other surface) so that the front surface of inset 1400 is flush or substantially flush with the surface of the wall. In some embodiments, inset 1400 can be flush with the wall while side surfaces 1215 extend inwardly into the housing through the wall. In some embodiments, inset 1400 can include side surfaces 1215 surrounding the top and sides of the aperture and extending inwardly into the aperture. Side surfaces 1215 can provide depth to the aperture. In some embodiments, inset 1400 does not include a lower recessed side surface. As shown in the figure, frames 1210 can be slightly recessed in order to provide an area to form into the wall, for example, with plaster or mud to create an effect where inset is flush with the wall. Moreover, side surfaces can have a depth of 2, 1.75, 1.5, 1.25, 1.0, 0.75, or 0.5 inches extending from the front surface of inset into the housing. In this way, the front edges of aperture 111 can be flush with the rest of the wall.

Some embodiments of the invention may not include inset 1400. In some embodiments, a frame can ring aperture 111 on the external surface of the wall like a picture frame. In some embodiments the frame may not be flush with the wall. The frame can take on any shape or design, for example, including shapes or designs that are standard for window trim or picture frames. Moreover, the frame may include side surfaces that extend inwardly into the housing through the wall.

FIG. 15A shows a side-view of an LED circuit board 608 arranged with lens 1520 according to some embodiments of the invention. LED circuit board 608 can include a plurality of LEDs 605 arranged in any geometric configuration on the circuit board 608. Any number of LEDs 605 can be arranged on the circuit board.

In some embodiments, lens 1520 can be coupled with circuit board 608. Lens 1520 can project light in an upward illumination distribution using a combination of refraction and total internal reflection. Lens 1520 can be used with primary optical subsystem 106. Lens 1520 includes pocket 1515 within which LEDs 610 are placed. In some embodiments, lens 1520 is positioned a small distance away from circuit board 608. For example, an injection molded plastic piece can be positioned between circuit board 608 and lens 1520 in order to provide thermal isolation. In some embodiments, lens 1520 can be secured a distance away from circuit board 608 using brackets or other mechanical means in order to provide thermal isolation.

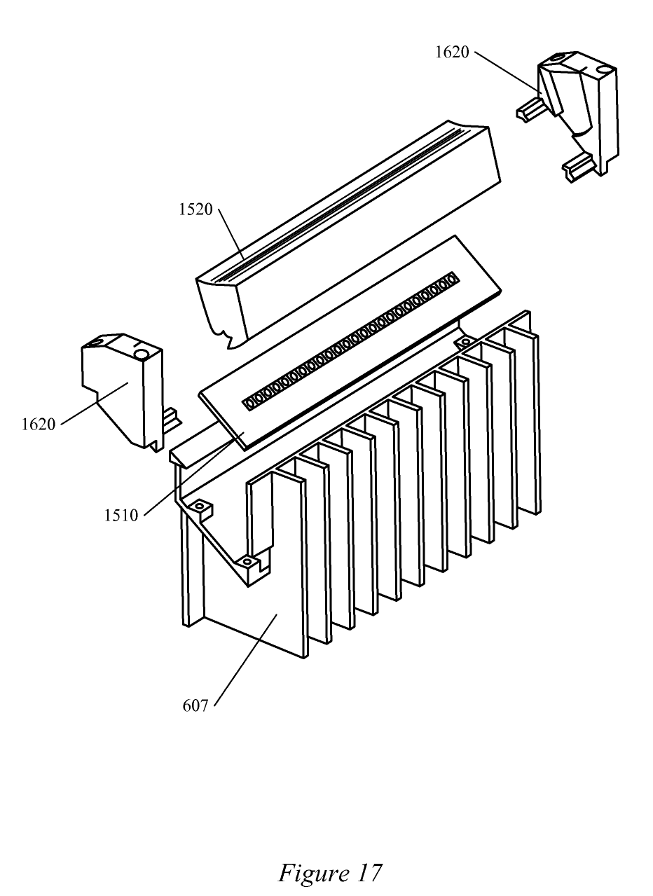

As shown in FIG. 17, the LEDs may not extend all the way across circuit board 608. This is done to reduce the amount of light that is incident on side surfaces (e.g., side surfaces 1215 shown in FIGS. 12A, 12B and 13) of a recessed luminaire. In other embodiments, the LEDs can extend all the way along circuit board 608.

FIG. 15B shows a three dimensional view of lens 1520. Lens 1520, for example, can be made from extruded or injection molded plastic. Various other manufacturing techniques can be used to manufacture lens 1520. Lens 1520 includes pocket 1515 that extends along the length of lens 1520 and allows for a plurality of LEDs that are arranged along the length of the lens to be positioned within pocket 1515. A holder or bracket can be coupled with the ends of lens 1520 that can keep lens positioned away from circuit board 608. Moreover, the holder or bracket can be coupled with a heat sink. The holder or bracket can be screwed into the heat sink and also contain features to apply pressure to the LED board for maximum thermal contact between the LED board and the heat sink.

FIG. 16 shows lens 1520 and circuit board 608 positioned within heat sink 607. Heat sink 607 can conduct heat away from circuit board 608 and/or lens 1520. Heat sink 607 also acts as a holder for lens 1520 and circuit board 608. In this way, proper conductive contact is assured. Various other heat sink configurations can be used. Holders 1620 can be used to secure lens 1520 and circuit board 608 together and within heat sink 607.

FIG. 17 shows an exploded view of portions of primary optical subsystem. Circuit board 608 includes LEDs arranged along the length of the board. Lens 1520 is positioned above circuit board 608. Holders 1620 coupled with the ends of circuit board 608 and lens 1520 can be used to keep some distance between circuit board 608 and lens 1520 and align LEDs to circuit board 608. Moreover, holders can be used to couple both circuit board 608 and lens 1520 with heat sink 607. Screws or bolts can be used to fasten holders 1620 with heat sink 607. As shown in the figure, holders 1620 have cutouts with the same cross-sectional shape as lens 1520.

Luminaires described herein can include any number of sizes, dimensions and/or configurations. For example, a luminaire housing can be less than 3.625 inches deep, in the in-wall direction. Luminaires can also have a width that is less than the standard commercial and/or residential stud width of 24 or 16 inches. That is, the width of the luminaire housing can be at or less than 22⅜ or 14⅜ inches.

In some embodiments, the primary optical subsystem and/or the secondary optical subsystem (or components thereof) can be located anywhere within the aperture. For example, primary optical subsystem and/or the secondary optical subsystem can be disposed on the sides, below, and/or above the aperture as well as within the aperture. Moreover, the secondary optical subsystem can include a plurality of secondary optical subsystems disposed in various locations and/or independently controllable in both spectrum and total output. For example, a first secondary optical subsystem can be disposed at the top of the aperture that provides blue light, and a second secondary optical subsystem can be disposed at the bottom that provides red light. This example can provide a vertical gradient from red to blue.

While many luminaries have been described in a wall-recessed configuration, embodiments of the invention are not limited thereby. Luminaires described herein may be recessed in any surface such as a ceiling, counter, ground, or floor. For example, in a ceiling configuration, the secondary optical subsystem may provide a light distribution representative of a skylight. In some configurations, the primary optical subsystem can provide indirect light on a wall. And in some configurations, a plurality of primary optical subsystems can exist and may provide indirect light on one or more walls.

In some embodiments, the primary optical subsystem can be used to provide a floor wash. For example, the luminaire system can be positioned near a floor with the secondary optical subsystem providing various illumination conditions and the primary optical subsystem illuminating the floor. Such a luminaire can be used for step or night lighting solutions.

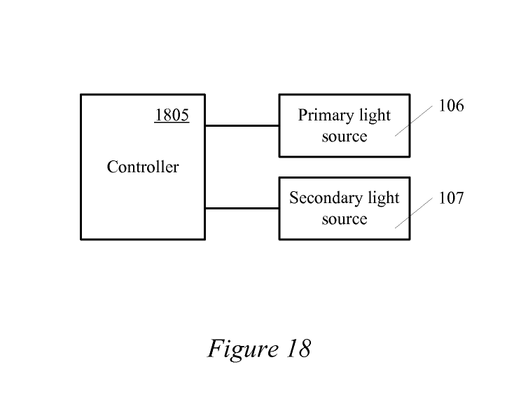

FIG. 18 shows a block diagram of controller 1805 coupled with primary optical subsystem 1810 and secondary optical subsystem 1815. Controller 1805 can control power to the light sources. In some embodiments, controller 1805 may control distinct light sources within primary optical subsystem 1810 and/or secondary optical subsystem 1815.

Controller 1805 can change the characteristic of the light emitted from primary optical subsystem 1810 and/or secondary optical subsystem 1815. For example, controller 1805 can be coupled with distinct light sources and/or dynamic filters to adjust the quantity of light and/or color of either or both primary optical subsystem 1810 and secondary optical subsystem 1815 throughout the day to correlate the quantity of light and/or color of light based on the time of day and/or day of the year. As one example, the produced light may be greater during midday and lesser at night. As another example, the produced light may include more red and yellow hues during sunrise and sunset. Controller 1805 may also be coupled with various actuators.

Controller 1805 may also adjust the brightness and/or color of the light based on real-time weather phenomena. For example, the controller can include a network card (e.g., WiFi or cellular network card etc.) that communicates with a database that updates local weather conditions in real-time. Based on information in the database, the controller can change the quantity of light, brightness, gradient and/or spectrum of the light produced by either or both the primary optical subsystem 1810 and secondary optical subsystem 1815 based on real-time weather events. As another example, the controller can include a database of weather events and can randomly adjust the characteristic of light by randomly selecting a weather event from the database. In some embodiments, the controller can dynamically control the quantity of light, brightness, luminous or chromatic gradient and/or color of the light emitted from the primary and/or secondary light sources in any way; for example, in a way that is visually interesting or pleasing and/or that adds to the ambiance of the architectural space.

In some embodiments, controller 1805 can provide independent control of primary optical subsystem 106 and secondary optical subsystem 107. This independent control can control the luminance, color, distribution, look, and/or feel of the light independently for the two optical subsystems. In some embodiments, controller 1805 can provide appearance compensation. For instance, when the emitted light of one optical subsystem changes from in appearance, the other subsystem can also change in order to compensate for the new look and feel of the overall system.

In some embodiments, a plurality of luminaires and/or luminaire subsystems can be controlled in a coordinated fashion. That is, the temporal and/or spatial effects can be created among the plurality of luminaires and/or luminaire subsystems. For example, in a first state, each of the plurality of luminaires and/or luminaire subsystems can provide a static luminous presentation. In a second state, a “ripple” of color could be sent across the plurality of luminaires and/or luminaire subsystems. As another example, a user could specify a different color scheme for the secondary component of each of four corners of a two dimensional array of luminaires and/or luminaire subsystems. A combination of software and/or control system can be used to automatically blend/transition the color of all the other luminaires based on each one's relative spatial proximity of the plurality of luminaires and/or luminaire subsystems.

In some embodiments, controller 1805 can include a plurality of controllers and/or drivers. Moreover, in some embodiments, controller 1805 can include multiple controllers distributed among a plurality of luminaries. Moreover, controller 1805 can include one or more light drivers.

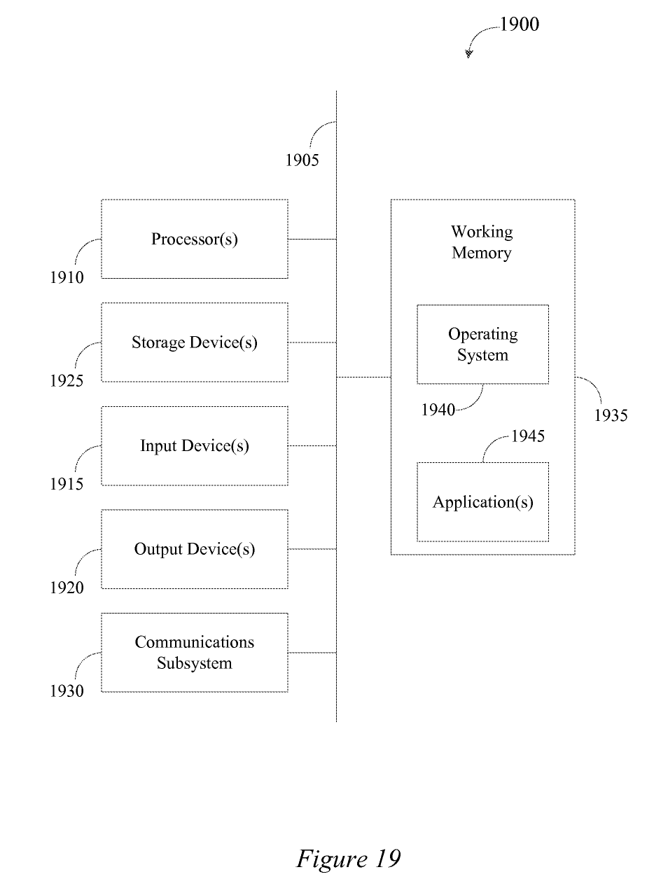

The computational system 1900, shown in FIG. 19, can be used to perform control functions described herein. Controller 1805 can include all or portions of computational system 1900. As another example, computational system 1900 can be used to perform any program or simulation described herein. Furthermore, computational system 1900 can be used to control various LEDs and/or light sources.

Computational system 1900 includes hardware elements that can be electrically coupled via a bus 1905 (or may otherwise be in communication, as appropriate). The hardware elements can include one or more processors 1910, including without limitation one or more general-purpose processors and/or one or more special-purpose processors (such as digital signal processing chips, graphics acceleration chips, and/or the like); one or more input devices 1915, which can include without limitation a mouse, a keyboard and/or the like; and one or more output devices 1920, which can include without limitation a display device, a printer and/or the like.

The computational system 1900 may further include (and/or be in communication with) one or more storage devices 1925, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computational system 1900 might also include a communications subsystem 1930, which can include without limitation a modem, a network card (wireless or wired), an infrared communication device, a wireless communication device and/or chipset (such as a Bluetooth device, an 802.6 device, a WiFi device, a WiMax device, cellular communication facilities, etc.), and/or the like. The communications subsystem 1930 may permit data to be exchanged with a network (such as the network described below, to name one example), and/or any other devices described herein. In many embodiments, the computational system 1900 will further include a working memory 1935, which can include a RAM or ROM device, as described above.

The computational system 1900 also can include software elements, shown as being currently located within the working memory 1935, including an operating system 1940 and/or other code, such as one or more application programs 1945, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 1925 described above.

In some cases, the storage medium might be incorporated within the computational system 1900 or in communication with the computational system 1900. In other embodiments, the storage medium might be separate from a computational system 1900 (e.g., a removable medium, such as a compact disc, etc.), and/or provided in an installation package, such that the storage medium can be used to program a general purpose computer with the instructions/code stored thereon. These instructions might take the form of executable code, which is executable by the computational system 1900 and/or might take the form of source and/or installable code, which, upon compilation and/or installation on the computational system 1900 (e.g., using any of a variety of generally available compilers, installation programs, compression and/or decompression utilities, etc.) then takes the form of executable code.

Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

What is claimed is:

1. A two-component luminaire comprising:
a housing comprising at least a first side that includes at least an inwardly facing surface;
an aperture within the first side having a peripheral edge defining a boundary between the aperture and the first side, wherein the peripheral edge includes a first peripheral edge segment and a second peripheral edge segment positioned opposite the first peripheral edge segment;
a primary optical subsystem disposed within the housing at a position located inwardly within the housing relative the first peripheral edge segment and proximate the inwardly facing surface, and configured to direct light through the aperture in a direction that is both outward from the housing through the aperture and tending in a direction toward the second peripheral edge segment; and
a secondary optical subsystem disposed within the housing, configured to direct light through the aperture.

2. The two-component luminaire according to claim 1, wherein the second optical subsystem is configured to direct at least 40% of the light both outward from the housing through the aperture and in a direction tending toward the first peripheral edge segment.

3. The two-component luminaire according to claim 1, wherein the first optical subsystem is configured to illuminate a surface substantially perpendicular with the first surface.

4. The two-component luminaire according to claim 1, wherein the luminance provided by the second optical subsystem is distributed across the aperture.

5. The two-component luminaire according to claim 1, further comprising a controller that independently controls the lumen output, luminance, brightness, color and/or color temperature of the first optical subsystem.

6. The two-component luminaire according to claim 1, wherein the second optical subsystem comprises a first plurality of light sources disposed within the housing proximate the inwardly facing surface and the second peripheral edge segment.

7. The two-component luminaire according to claim 1, wherein the second optical subsystem comprises a first plurality of light sources disposed within the housing proximate the inwardly facing surface and the first peripheral edge segment.

8. The two-component luminaire according to claim 1, wherein the second optical subsystem comprises a first plurality of light sources and a second plurality of light sources disposed within the housing, and wherein the two-component luminaire further comprises a controller that independently controls the first plurality of light sources and the second plurality of light sources.

9. The two-component luminaire according to claim 1, further comprising a diffuser disposed within the housing, wherein the majority of light from the second optical subsystem passes through the diffuser prior to exiting the housing through the aperture.

10. The two-component luminaire according to claim 9, wherein the diffuser has a surface area larger than an area of the aperture within the first side.

11. The two-component luminaire according to claim 9, wherein the diffuser is configured to be removed from within the housing through the aperture.

12. The two-component luminaire according to claim 1, wherein the first optical subsystem comprises a plurality of light sources that produce substantially white light.

13. The two-component luminaire according to claim 1, wherein the second optical subsystem comprises a plurality of light sources that includes at least one red light source, at least one green light source, and at least one blue light source.

14. The two-component luminaire according to claim 1, further comprising a plurality of sidewalls disposed proximate the peripheral edge of the aperture and extending perpendicularly into the housing from the peripheral edge.

15. The two-component luminaire according to claim 14, further comprising a diffuser disposed within the housing behind the sidewalls, wherein the majority of light from the second optical subsystem passes through the diffuser prior to exiting the housing through the aperture.

16. The two-component luminaire according to claim 1, further comprising a second aperture, a second primary optical subsystem disposed to direct light though the second aperture, a second secondary optical subsystem disposed to direct light though the second aperture, and a controller configured to independently control the lumen output, luminance, brightness, color and/or color temperature of light from the primary optical subsystem, the secondary optical subsystem, the second primary optical subsystem, and the second secondary optical subsystem are independently controlled.

17. A two-component luminaire comprising:
a housing having an aperture in a first housing wall;
a primary optical subsystem configured to indirectly illuminate an architectural space through the aperture; and
a secondary optical subsystem configured to directly illuminate the architectural space through the aperture,
wherein the primary optical subsystem and the secondary optical subsystem are recessed within the housing.

18. The two-component luminaire according to claim 17, further comprising a diffuser disposed within the housing between the secondary optical subsystem and the aperture.

19. The two-component luminaire according to claim 18, wherein the diffuser is collapsible such that it can be removed from the luminaire through the aperture.

20. The two-component luminaire according to claim 18, wherein the diffuser is curved along a horizontal axis.

21. The two-component luminaire according to claim 18, wherein the diffuser is tilted along a horizontal axis.

22. The two-component luminaire according to claim 17, wherein the secondary optical subsystem comprises a plurality of color LEDs.

23. The two-component luminaire according to claim 17, further comprising a controller coupled with the secondary optical subsystem and the primary optical subsystem, wherein the controller is configured to independently control the secondary optical subsystem and the primary optical subsystem.

24. The two-component luminaire according to claim 17, wherein the aperture comprises a vertical plane and the primary optical subsystem provides a photometric distribution through the aperture that is substantially above horizontal.

25. The two-component luminaire according to claim 17, wherein the aperture comprises a vertical plane and the secondary optical subsystem provides a photometric distribution through the aperture having a largely uniform distribution.

26. The two-component luminaire according to claim 17, wherein the primary optical subsystem emits light with more lumens than the secondary optical subsystem.

27. The two-component luminaire according to claim 17, wherein the secondary optical subsystem produces one percent to fifteen percent of the total light output from the luminaire.

28. The two-component luminaire according to claim 17, wherein the primary optical subsystem is disposed within the housing near the bottom of the aperture.

29. The two-component luminaire according to claim 17, wherein the primary optical subsystem comprises:
a plurality of white LEDs, tunable white colored LEDs, or mixed color temperature white LEDs, and
a lens.

30. The two-component luminaire according to claim 17, wherein the luminaire includes a mixing chamber disposed within the housing.

31. The two-component luminaire according to claim 17, wherein the housing comprises a depth less than 3.625 inches.

32. The two-component luminaire according to claim 17, wherein the housing comprises a width less than 24 inches.

33. The two-component luminaire according to claim 17, further comprising a first side surface coupled with a top edge of the aperture, a second side surface coupled with a side edge of the aperture, and a third side surface coupled with a side edge of the aperture.

34. The two-component luminaire according to claim 17, further comprising a diffuser disposed within the housing

35. The two-component luminaire according to claim 1, further comprising a diffuser positioned within the housing near the aperture such that a majority of the light from the first optical subsystem exits the aperture without interacting with the diffuser.

36. The two-component luminaire according to claim 17, wherein the secondary optical subsystem comprises a light source selected from the group consisting of a plurality of multi-color LEDs, an LCD display, an OLED display, an LED matrix, and a plasma display.

37. A two-component luminaire comprising:
a housing comprising at least a first side that includes at least an inwardly facing surface;
an aperture within the first side having a peripheral edge defining a boundary between the aperture and the first side, wherein the peripheral edge includes a first peripheral edge segment and a second peripheral edge segment positioned opposite the first peripheral edge segment;
a primary optical subsystem disposed within the housing at a position located inwardly within the housing relative the first peripheral edge segment and proximate the inwardly facing surface, and configured to direct light through the aperture in a direction that is both outward from the housing through the aperture and tending in a direction toward the second peripheral edge segment; and
a secondary optical subsystem disposed within the housing, configured to direct light through the aperture; and
a controller, wherein:
the controller is electrically coupled with the primary optical subsystem and the secondary optical subsystem, and
the controller is configured to independently control operation of the primary optical subsystem and the secondary optical subsystem.

38. The two-component luminaire according to claim 37, further comprising a diffuser positioned within the housing between the secondary optical subsystem and the aperture such that light from the secondary optical subsystem exits the aperture through the diffuser.

39. The two-component luminaire according to claim 37, further comprising a diffuser positioned within the housing near the aperture such that a majority of the light from the first optical subsystem exits the aperture without interacting with the diffuser.

40. A two-component recessed luminaire comprising:
a housing having an aperture, wherein the housing has width less than 24 inches and a depth less than 3.625 inches;
a primary optical subsystem disposed within the housing and configured to illuminate an architectural space through the aperture with a photometric distribution where at least 80% of emitted light is directed above the aperture; and
a secondary optical subsystem disposed within the housing and configured to illuminate the architectural space through the aperture.

41. The two-component recessed luminaire according to claim 40, wherein the primary optical subsystem is disposed within the housing at a level below a bottom portion of the aperture.

42. The two-component recessed luminaire according to claim 40, wherein the secondary optical subsystem is configured to illuminate an architectural space through the aperture with a photometric distribution that is substantially downward.

43. A two-component luminaire comprising:
a housing comprising at least a first side that includes at least an inwardly facing surface;
an aperture within the first side having a peripheral edge defining a boundary between the aperture and the first side, wherein the peripheral edge includes a first peripheral edge segment and a second peripheral edge segment positioned opposite the first peripheral edge segment;
a primary optical subsystem disposed within the housing at a position located inwardly within the housing relative the first peripheral edge segment and proximate the inwardly facing surface, and configured to illuminate a surface substantially perpendicular with the first surface, the; and
a secondary optical subsystem disposed within the housing, configured to direct light through the aperture, configured to distribute the luminance from the second optical subsystem across the aperture, and configured to direct at least 40% of the light both outward from the housing through the aperture and in a direction tending toward the first peripheral edge segment.
